(19) United States
(12) Patent Application Publication
(10) Pub. No.: US 2009/0195696 A1
(43) Pub. Date: Aug. 6, 2009

(54) Channel system and method

(75) Inventor: James T. McDaniel, Nashville, TN (US)

Correspondence Address: NIXON & VANDERHYE, PC, 901 NORTH GLEBE ROAD, 11TH FLOOR, ARLINGTON, VA, 22203, US

(73) Assignee: Toshiba America Consumer Products, LLC, Wayne, NJ (US)

(21) Appl. No.: 12/318,759

(22) Filed: Jan. 7, 2009

Related U.S. Application Data
(60) Provisional application No. 61/006,315, filed on Jan. 7, 2008.

(51) Int. Cl. H04N 5/50; H04N 5/44

(52) U.S. Cl. 348/570; 348/734; 348/E05.097; 348/E05.096

(57) ABSTRACT

Example methods and systems of finding channels related to a currently tuned channel involve receiving an input invoking a related channel function. In response to the input, a list of related channels is generated based at least in part on a currently tuned channel and the generated list of channels is displayed on a television screen. One of the related channels on the displayed list may be tuned in response to an input selecting that channel.

### CROSS-REFERENCE TO RELATED APPLICATION

This application claims the benefit of provisional U.S. application No. 61/006,315, filed Jan. 7, 2008, the contents of which are incorporated herein in their entirety.

### BACKGROUND AND SUMMARY

The subject application generally relates to systems and methods that can be used in any television-type product to quickly identify channels that are related to the one currently tuned. These related channels could be the equivalent analog/digital channel to the one tuned or may be channels that are related by name or are showing the same program.

Television viewers often have hundreds and sometimes thousands of channels to choose among for viewing. Various aids have been developed to assist users in selecting from among these channels. For example, electronic program guides (EPG's) or interactive program guides (IPGs) provide displays on a television screen from which a user can find and select programs of interest. These displays may be configured to provide listings by channels, by time, or by program theme.

This application describes example systems and methods of finding channels related to a currently tuned channel. When an input is received to invoke a related channel function, a list of related channels is generated, based at least in part on a currently tuned channel, and the generated list of channels is displayed on a television screen. One of the related channels on the displayed list may be tuned in response to an input selecting that channel.

This function markedly increases the efficiency with which associated digital channels, sister channels, and channels carrying the same program can be identified and tuned. It reduces the tedium of bringing up an EPG, navigating to the appropriate search screen, executing a search, and then tuning to the desired channel to a small number of very simple steps: (1) pressing a button on the remote control to invoke the related channel function, and then (2) selecting a related channel from a related channel list displayed when the function is invoked.

### BRIEF DESCRIPTION OF THE DRAWINGS

FIG. 1 is a highly generalized block diagram of an example television 100 in which the example systems and methods described herein may be implemented.

FIG. 2 provides a more detailed view of example remote control 150 in FIG. 1.

FIG. 3 shows an example display of related channels.

FIG. 4 is a flow chart showing an example related channel function.

FIGS. 5A and 5B show example program guide database portions that may be used in the related channel systems and methods described herein.

### DETAILED DESCRIPTION OF EXAMPLE EMBODIMENTS

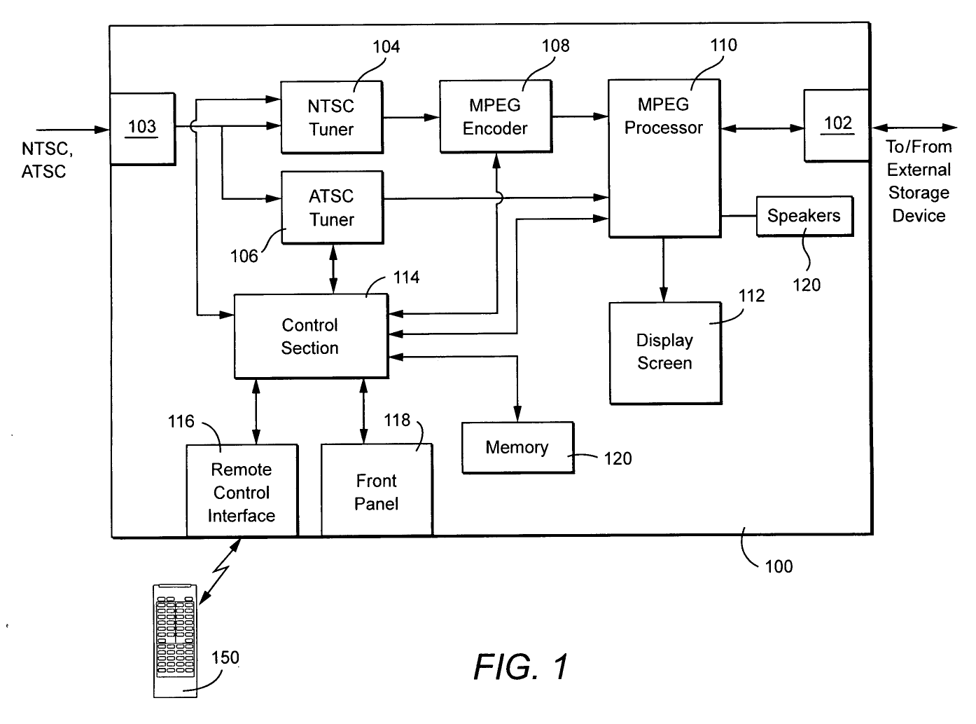

FIG. 1 is a highly generalized block diagram of a television 100 in which the example systems and methods described herein may be implemented. The details of television 100 are provided by way of example only and it will be readily apparent that the systems and methods described herein may be implemented in a wide variety of televisions of different configurations, both analog and digital.

An input 103 of the television receives NTSC and ATSC signals. The NTSC signals are supplied to an NTSC tuner 104 and the ATSC signals are supplied to an ATSC tuner 106. Other inputs (not shown) may also be supplied to the television. For example, the television may receive HDMI signals or the output from a DVD player. The output of NTSC tuner 104 is supplied to an MPEG encoder 108 which MPEG encodes the tuned NTSC signal. The outputs of ATSC tuner 106 and MPEG encoder 108 are supplied to an MPEG AV processor 110. MPEG AV processor 110 processes the MPEG transport stream from the ATSC tuner 106 and/or MPEG encoder 108 and supplies a display signal to display screen 112 and a sound signal to speakers 120. MPEG AV processor 110 also selectively outputs an MPEG transport stream to and receives an MPEG transport stream from an external storage system via interface 102. The external storage system may, for example, include a hard disk drive (HDD) recording device, a DVD recording device, or an HDD/DVD recording device. Generally speaking, MPEG AV processor 110 is a standard processing system used in conventional digital integrated televisions, monitors and set-top box (STB) units that receives MPEG compressed AV data and decompresses and processes the AV data for output via display screen 112 and speakers 120.

A control section 114, including a CPU, for example, controls the overall operations of television. 100. In general, control section 114 may include, for example, a microprocessor, a microcontroller, a processor, a controller, an application specific integrated circuit (ASIC), logic circuitry, a state machine and/or combinations thereof. Control section 114 may be supplied with inputs from a user via a remote control interface 116 (e.g., a wireless infrared receiver) for a remote control 150 (e.g., an infrared remote control) and front panel keys 118. MPEG AV processor 110 may selectively block output of audio and/or video in accordance with control signals from control section 114.

Memory 120, which may be a combination of volatile and non-volatile semiconductor memory, stores various operating programs and user settings (e.g., rating level(s) set by parents) used by control section 114 to control the operation of television 100. For example, memory 120 may include ROM storing operating programs for execution by the control section 114, including an operating program for implementing the systems and methods described herein. These operating programs may provide for control of tuners 104, 106; control of MPEG AV processor 110 to generate displays for display on display screen 212 and sounds for output via speakers 120; processing of inputs supplied by a user via front panel 118 and/or remote control 150; and the like. Memory 120 may also include SDRAM for use by control section 114 during execution of the operating programs.

Television 100 may also be provided with an electronic program guide. Generally speaking, an electronic program guide uses program guide data transmitted to the television to provide the user with on-screen displays of television program schedules. For example, the on-screen display may be in the form of a grid in which channels are arranged vertically and time extends horizontally. Titles of programs are shown in cells in the grid and the horizontal dimension of the cell is indicative of the length of the corresponding program. The electronic program guide may also enable a user to select programs from the grid (or from some other display of program titles) for viewing and recording. In the case of selecting a program from the program guide for viewing, the television is controlled to tune to the channel showing the selected program. In the case of selecting a program for future recording, a program timer is generated with relevant recording information (e.g., start time, end time, channel). At the program start time, the television is controlled to tune to the selected channel and command(s) may be issued to turn on and place a recording device in record mode (e.g., to the external storage device via interface 102). At the program end time, command(s) may be issued to stop the record mode and turn off the recording device. In addition, electronic program guides also often provide the capability of displaying listings of programs by themes and titles. Electronic program guides are available from various providers including Gemstar-TV Guide.

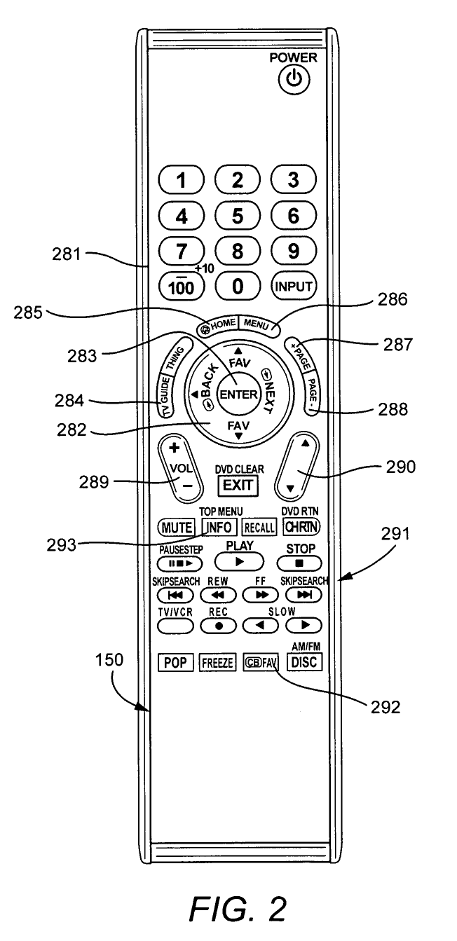

FIG. 2 shows an example layout of keys and buttons for remote control 150. The keys or buttons of remote control 150 may be appropriately labeled to assist the user in selecting a desired function. Alternatively or additionally, television 100 may provide one or more displays that inform the user which key(s) or button(s) should be actuated to input desired commands. Other types of inputs such as voice inputs may also be used to input commands in certain implementations.

Remote control 150 includes a numeric keypad 281 including the numbers 0-9. Keypad 281 also includes a “-/100” key for use in entering channel numbers greater than 100 and a delimiter for separating major and minor channel numbers (e.g., channel 125-3). An “Input” key is provided for use in switching between different inputs to television 100 (e.g., different antennas, different video inputs, different devices connected to the television, etc.). Remote control 150 also includes a navigation switch 282 that provides for up, down, left and right navigation through menus, program guides, and the like. An enter key 283 is also provided. Various keys are provided around part of the periphery of navigation switch 282. A “program guide” key 284 causes a program guide to be displayed. A “home” key 285 causes television 200 to tune to a HOME channel. A “menu” key 286 causes television 200 to display an initial menu screen for accessing various features of television 200. A “Page +” key 287 and a “Page −” key 288 provide for navigation through menus, program guides, etc. A volume up/down key 289 and a channel up/down key 290 permit the user to set the volume level and to select television channels. A DVD/VCR keypad 291 allows the user to control a DVD player and/or a VCR. A “Fav” key 292 accesses a favorite channel feature. An “Info” key 293 can be pressed by a user to access additional information on a particular topic.

It will of course be appreciated that the function(s) associated with the various keys and buttons of the remote controls described above may vary depending on the state of television 100 (e.g., watching television, moving through menus, making menu selections, etc.). Moreover, the layout of the keys and buttons shown in FIG. 2 is not intended to be limiting in any way and various designs for laying out these keys and buttons may be adopted.

The systems and methods described herein allow users to find channels related to the channel they are currently viewing. For example, while viewing an analog channel on a HD-Integrated TV, a user may wonder if the digital channel equivalent is available in order to possibly view the current program in high definition. The systems and methods described herein allow a user to press a button on a remote control that prompts the television to search for channel names that begin with the same letters as the current channel and display them in a small window so that the user can easily select and tune one of those channels. Most of the time, the digital equivalent of an analog channel will begin with the same call letters, but have “-HD” added to the end, so it will be found in a search like this. Also presented to the user may be any other channels currently showing a program having the same name as the one being viewed, with emphasis on those in high definition. Additionally, the systems and methods described herein can be used to find other channels related to the one currently tuned. For example, if ESPN is tuned, ESPN2, ESPN-Classic, ESPN-News, etc. could all be quickly located using this search.

The systems and methods described herein use any method available to them which provides channel name and/or program name/resolution information. One way to retrieve such data is via a program guide database stored in memory 120 to which access may be made via an API (application programming interface), for example.

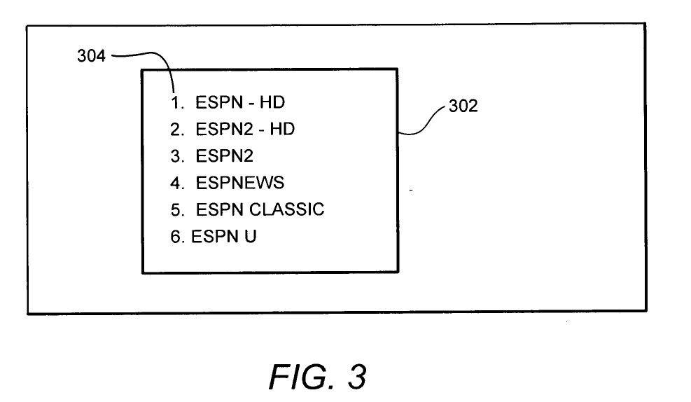

When the user invokes the related-channel function, for example by pressing a specified key (or keys) on remote control 150, the available information is searched to find channels whose names begin with the same three letters as the currently-tuned channel. The remote control key for invoking the function may be a key dedicated to the related channel function or may be some combination of keys (e.g., a function key followed by a number key). Also, the programs currently showing on other channels are searched to see if any have a name that exactly matches that of the program on the current channel. The list of channels found that have a matching name or program is then presented to the user in a window 302 such as that shown in FIG. 3. Channels that have high definition programs currently showing are emphasized by, for example, being placed at the top of the list. Each channel in window 302 has an index 304 so that the user can press that number on the remote control while window 302 is displayed to immediately go to that channel and hide the window. If more than a certain number (e.g., ten) matching channels are found, the window will display ten matches and allow the user to use navigation switch 282 to scroll to the others, always keeping ten visible so that the quick indexing capability is available to the user.

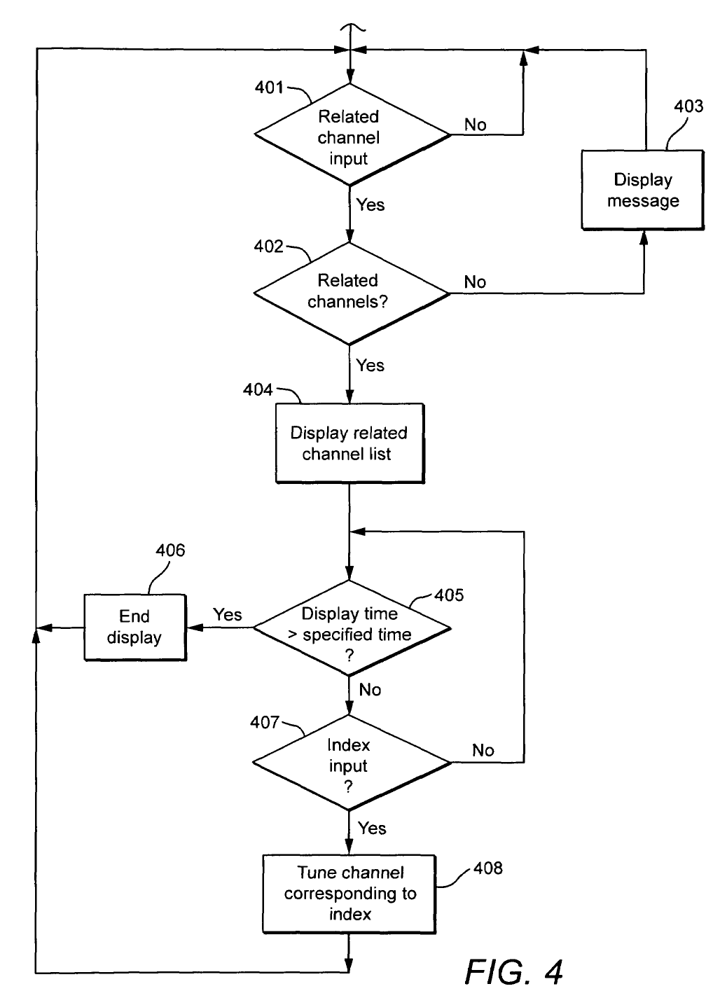

FIG. 4 is a flow chart showing steps of an example method of displaying related channels. At step 401, the method awaits an input invoking the related channel function. As mentioned above, this function may be invoked by pressing a specified key or keys on a remote control. If such an input is received, a determination is made at step 402 as to whether there are any related channels (e.g., any channel(s) whose first three call letters are the same as the currently tuned channel and/or any channel(s) showing the same program as that showing on the currently tuned channel). If no related channels are found, a message to this effect is displayed on the television (step 403) and the method returns to step 401 awaiting an input invoking the related channel function.

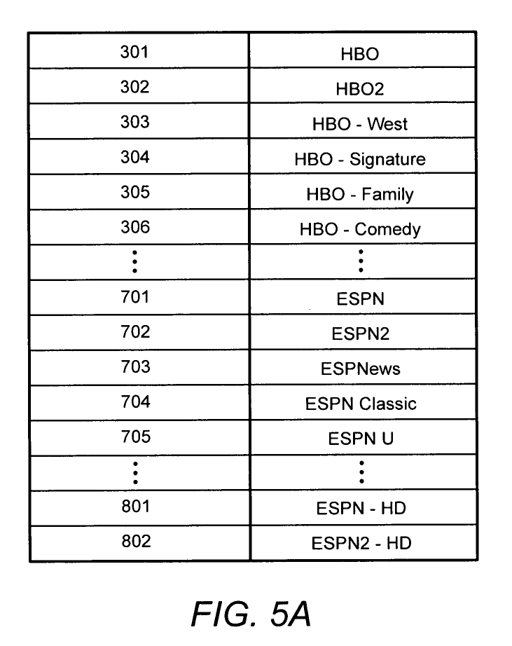

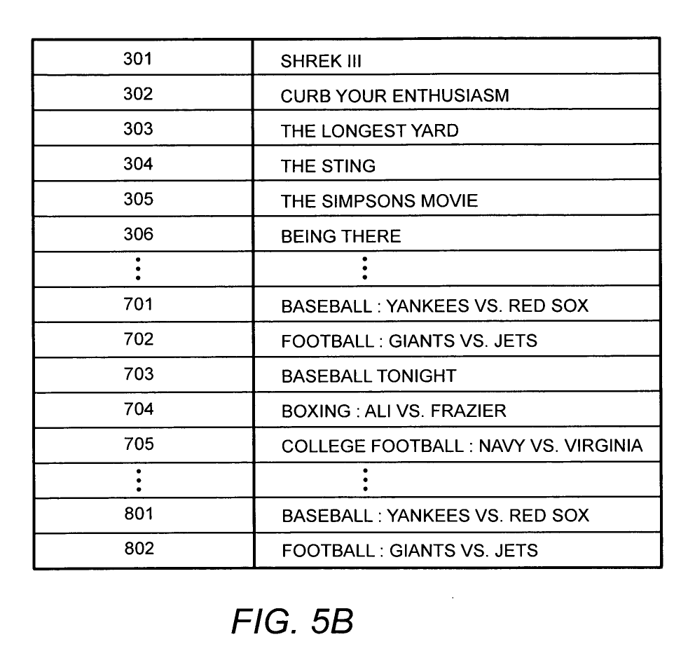

Related channels may be identified by, for example, control section 114 searching a program guide database stored in memory 120. Such a database may include channel information for the channels received by the television including channel numbers (301, 302, 303, etc.) and channel identifiers such as channel names or call letters (e.g., HBO, HBO2, HBO West, HBO Signature, HBO Family, HBO Comedy, etc.). FIG. 5A shows an example of a portion of a program guide database containing this information. Other information (not shown) such as whether a particular channel is a high-definition channel or channel-type information (e.g., News, Sports, Movies, etc.) may also be contained in the database. The program guide database may also include information about programs currently showing on the channels received by the television. FIG. 5B shows an example of a portion of a program guide database containing this information. Although FIGS. 5A and 5B suggest that information respectively shown therein is stored in different tables, the information may be stored in the same table.

Control section 114 searches the program guide database to identify related channels by, for example, comparing the identifier or call letters for the currently-tuned channel with the channel information shown in FIG. 5A. If the comparison shows that a specified relationship exists between the identifier or call letters for the currently tuned channel and one or more channels for which channel information exists, those one or more channels are included in a related channel list. The specified relationship may be, for example, matching of the first three letters of the identifier or call letters of the currently tuned channel and those of the other channels stored in the program guide database. Thus, if a user is currently tuned to “ESPN”, ESPN2, ESPNews, ESPN Classic, ESPN U, ESPN-HD and ESPN2-HD would be included in the related channel list. Control section 114 also searches the program guide database to identify related channels by determining whether any other channels are currently showing the same program that is on the currently tuned channel. Any such channels are also included in the related channel list.

If step 402 determines that there are related channels, a list of the related channels is displayed on the television at step 404. Preferably, this list is displayed as a semi-transparent overlay on the video of the currently-tuned channel. Of course, it will be appreciated that other manners of displaying the list may also be used.

As shown in FIG. 3, each channel in the related channel list has a corresponding index. This index is preferably a number that can be input using remote control 150 in order to the tune to the corresponding related channel. The indices and ordering of the related channels on the related channel list is determined by control section 114. For example, the related channels may be ordered alphabetically (e.g., “HBO Comedy” appears in the list before “HBO Signature”) and the indices may be assigned in numerical order beginning with the first related channel in the list (i.e., 1, 2, 3, etc.).

At step 405, a determination is made as to whether the amount of time the related channel list has been displayed exceeds a specified display time (e.g., 10 seconds). If so, the display of the related channel list ends (step 406) and the method returns to step 401 and awaits an input invoking the related channel function. If, at step 405, the related channel list display time does not exceed the specified display time, a determination is made at step 407 as to whether an index is input while the related channel list is displayed on the television. If so, the channel corresponding to the input index is tuned (and display of the related channel list ends) at step 408 and the method returns to step 401 and awaits an input invoking the related channel function. If an index is not input at step 407, the method returns to step 405.

In another example implementation, channels related to each channel may be stored in the program guide database so that a search need not be conducted each time the related channel function is invoked. In other words, an initial search (e.g., when the television is powered on or during a set-up procedure) may be made for channels related to each of the channels received by the television and the results of this search may be stored in the program guide database or elsewhere in memory 120. Such an approach can improve responsiveness to the invoking of the related channel function.

In yet another example implementation, the search for related channels may be conducted when a user tunes to a particular channel and a related channel list with corresponding indices can be generated at that time and stored in memory 120 until the channel is changed, at which time a new related channel list is generated. If the user remains tuned to a particular channel for a long time, the search may be periodically repeated (e.g., every half-hour). This approach can also improve responsiveness.

The related channels displayed on the television screen need not have indices respectively associated therewith. Instead, a cursor or highlight may be used to select a channel on the list by using navigation switch 282 on remote control 150 to position the cursor or highlight and then pressing enter switch 283 to make the selection.

The related channel function described herein markedly increases the efficiency with which associated digital channels, sister channels, and channels carrying the same program can be identified and tuned. It reduces the tedium of bringing up an EPG, navigating to the appropriate search screen on it, executing a search, and then tuning to the desired channel to a small number of very simple steps: (1) pressing a button on the remote control, and then (2) pressing a number on the remote control.

The various aspects of the systems and methods described herein may be implemented as part of an operating program executed by control section 114. This program can, for example, be tangibly embodied or stored on a computer-readable medium such as memory 120. Memory 120 may include magnetic memory, optical memory, semiconductor memory, magneto-optic memory, combinations thereof and the like and may, in some instances, be removable, as in a removable memory card. In another example, the program may be available for downloading over the internet so that the program may be delivered to television 100 via a communication network. Updates may be provided via downloads to television 100. Further, a carrier wave may be modulated by a signal representing the corresponding program and an obtained modulated wave may be transmitted, so that the television that receives the modulated wave may demodulate the modulated wave to restore the corresponding program.

While the systems and methods have been described in connection with what is presently considered to practical and preferred embodiments, it is to be understood that these systems and methods are not limited to the disclosed embodiments, but on the contrary, is intended to cover various modifications and equivalent arrangements included within the spirit and scope of the appended claims.

I claim:

1. A method of finding channels related to a currently tuned channel, the method comprising:
receiving an input invoking a related channel function;
generating, in response to the input, a list of related channels based at least in part on a currently tuned channel;
displaying on a television screen the generated list of related channels; and
tuning one of the related channels on the displayed list in response to an input selecting that channel.

2. The method according to claim 1, wherein each channel on the list of related channels has an associated index and the selecting of a related channel for tuning is responsive to input of the index for the selected channel.

3. The method according to claim 1, wherein the input invoking the related channel function is input using a remote control.

4. The method according to claim 1, wherein the list of related channels is based on the call letters of the currently tuned channel.

5. The method according to claim 4, wherein the list of related channels includes channels whose call letters begin with the same three or more characters as the call letters of the currently tuned channel.

6. The method according to claim 1, wherein the list of related channels is based on a program showing on the currently tuned channel.

7. The method according to claim 6, wherein the list of related channels includes channels showing the same program as that showing on the currently tuned channel.

8. An apparatus comprising:
an input device for supplying an input that invokes a related channel function;
a processor programmed to be responsive to the input to generate a list of related channels based at least in part on the currently tuned channel, display the generated list of television channels on a television screen, and tune one of the related channels on the list in response to an input selecting that channel.

9. The apparatus according to claim 8, wherein the list of related channels is based on the call letters of the currently tuned channel.

10. The apparatus according to claim 9, wherein the list of related channels includes channels whose call letters begin with the same three or more characters as the call letters of the currently tuned channel.

11. The apparatus according to claim 8, wherein the list of related channels is based on a program showing on the currently tuned channel.

12. The apparatus according to claim 11, wherein the list of related channels includes channels showing the same program as that showing on the currently tuned channel.

13. A computer-readable medium having stored thereon a program for method of finding channels related to a currently tuned channel, the method comprising:
receiving an input invoking a related channel function;
generating, in response to the input, a list of related channels based at least in part on a currently tuned channel;
displaying on a television screen the generated list of related channels; and
tuning one of the related channels on the list in response to an input selecting that channel.
